(19) United States
(12) Patent Application Publication
(10) Pub. No.: US 2005/0071827 A1
(43) Pub. Date: Mar. 31, 2005

(54) Method and apparatus for bit field optimization

(76) Inventor: Michael Y. Lai, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/674,364

(22) Filed: Sep. 29, 2003

(51) Int. Cl. G06F 9/45

(52) U.S. Cl. 717/146; 717/151; 717/152

(57) ABSTRACT

An apparatus and methods are provided for optimizing bit fields in compiled code. The methods may be performed by a bit-field optimizer of a compiler. The bit-field optimizer generates optimized code for software code that includes bit-field instructions.

### BACKGROUND

1. Technical Field

The present disclosure relates generally to information processing systems and, more specifically, to compiling code for a network processor such that bit fields in the compiled code are processed efficiently.

2. Background Art

A compiler is a software program that translates a source program (referred to herein as “source code”) into machine instructions (referred to herein as “object code”) that can be executed on a hardware processor. The source code is typically written in a high-level programming language such as C, Microengine C, Pascal, FORTRAN, or the like.

When generating object code, a compiler operates on the entire source program as a whole. This is in contrast to, for example, interpreters that analyze and execute each line of source code in succession. Because compilers operate on the entire source program, they may perform optimizations that attempt to make the resultant object code more efficient. Optimizing compilers attempt to make the object code more efficient in terms of execution time and/or memory usage. One example of an optimizing compiler is the Intel® Microengine C Compiler for the Intel® IXP2XX Product Line.

The C programming languages, including Microengine C, support definition of bit fields within a structure data type. The bit field definitions denote a set of adjacent bits in the structure data type. Bit fields provide a simple means to compactly pack small data components into an aggregate structure. Many source programs written for network processors, such as the Intel® DXP220 Service-Specific Network Processor and the Intel® DCP225 Service-Specific Network Processor, define bit fields. These programs frequently process the bit fields by initializing them, reading from them, writing to them, and testing their values.

### BRIEF DESCRIPTION OF THE DRAWINGS

The present invention may be understood with reference to the following drawings in which like elements are indicated by like numbers. These drawings are not intended to be limiting but are instead provided to illustrate selected embodiments of a method and apparatus for optimizing bit fields in compiled code.

FIG. 1 is a flowchart illustrating at least one embodiment of a method for optimizing software code that includes bit-field instructions.

FIG. 2 is a data flow diagram illustrating an embodiment of flow of control and data during at least one embodiment of bit-field optimization.

FIG. 3 is a flow diagram illustrating at least one embodiment of a method for performing bit-field optimization.

FIG. 4 is a flowchart illustrating at least one embodiment of a method for performing local registerization.

FIG. 5 is a block diagram illustrating at least one embodiment of a processing system capable of utilizing disclosed techniques.

### DETAILED DESCRIPTION

Described herein are selected embodiments of an apparatus and methods for optimizing bit fields in compiled code. In the following description, numerous specific details such as processor types, programming languages, specific compilers, and order of control flow for operations of a method have been set forth to provide a more thorough understanding of the present invention. It will be appreciated, however, by one skilled in the art that the invention may be practiced without such specific details. Additionally, some well-known structures, circuits, and the like have not been shown in detail to avoid unnecessarily obscuring the present invention.

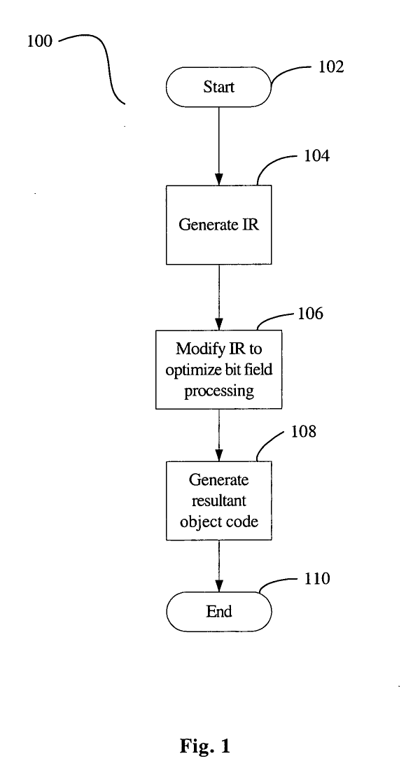

FIG. 1 is a flowchart illustrating at least one embodiment of a method 100 for optimizing the processing of bit fields in compiled software code, where the original source program includes one or more instructions for processing data in a bit field within a data structure. As used herein, “optimizing” implies that the object code pertaining to the bit fields has been modified such that instructions and operations involving bit fields are more efficient in terms of memory usage or execution time, or both. Such optimization method 100 is performed, for at least one embodiment, by a compiler. However, the optimization method 100 is not so limited, and can also be performed in other known manners, such as manually or by an assembler. As used herein, when reference is made to a “compiler” performing the method 100, it will be understood that any other known manner of performing the method is also intended by such statements.

The method 100 provides for generation 108 of resultant object code that has been optimized to efficiently execute one or more instructions for processing data in bit fields. As used herein, the term “resultant” object code is intended to encompass binary code that is generated by a compiler, hand-generated binary code, assembled code generated by an assembler, hand-assembled code, and the like.

Bit fields are widely used in source programs written for network processors. A typical network processor includes a memory system having a plurality of memory types. At least one embodiment of a memory system for a network processor includes a local memory as well as external dynamic random access memory (DRAM) and external static random access memory (SRAM). Each of the local memory, SRAM, and DRAM has a latency that is different from the others. Also, each of the local memory, SRAM, and DRAM may have a size that is different from the others.

A source program may declare bit fields for structures in any of the memory types. For example, consider the following illustrative code excerpt written in the Microengine C programming language:

| | |
|---|---|
| _declspec (dram) struct | (1) |
| { | |

int field1:16;
int field2:16;

| } a, b; | |
|---|---|
| a.field1 = b.field1; | (2) |
| a.field2 = b.field2; ... | (3) |

Statement (1) in the preceding code excerpt defines an unnamed structure type in DRAM to have two 16-bit integer bit-fields. Two variables, a and b, are declared of the structure type. Statements 2 and 3 in the code excerpt effectively manipulate only certain bits (referred to as a “bit field”) within each of structures a and b. Statements 2 and 3 thus each indicate processing for a respective bit field, and are referred to herein as “bit-field instructions.”

Due to the type of applications traditionally performed on network processors, network processing software programs tend to include many bit-field declarations such as those illustrated in statements (1) through (3), above. Such programs operate on data, such as signals and packets, that lend themselves to such bit-field declarations and processing. The memory hierarchy of at least one embodiment of a network processor is such that accesses, such as reads and writes, of bit fields may suffer relatively long latencies.

A second sample code excerpt illustrates a structure “packet” for which four individual bit fields are defined in order to facilitate packet processing for a typical network processor application:

| | |
|---|---|
| struct packet { | (4) |

int network_switch1 : 5;
int network_switch2 : 3;
int network_flag1 : 20;
int network_flag2 : 4;

}

The code excerpt defines a data structure type having four bit fields, where the first bit field is 5 bits in length, the second bit field is three bits in length, and the third and fourth bit fields are twenty and four bits in length, respectively. The statement defines a structure with the logical representation illustrated in Table 1.

TABLE 1
“packet” (32 bits)

| | | | |
|---|---|---|---|
| Network_switch1 | Network_switch2 | Network_flag1 | Network_flag2 |
| 5 bits | 3 bits | 20 bits | 4 bits |

While accessing all 32 bits of the “packet” structure might work well for other types of applications, at least one embodiment of an illustrative network processor application benefits from being able to access only a single bit field within the structure. For example, typical network processing applications deal with transmission of data packets that include various fields within a larger structure. To access a field, such as network_switch1, within a data structure such as “packet” illustrated in Table 1, the code of the software application may specify “packet.network_flag1” as an operand.

FIG. 1 thus illustrates a method for modifying a software program so that bit field processing is optimized in the resultant code. The method 100 may be performed by hand, or may be performed automatically by a compiler, assembler, or the like. Processing begins at block 102 and proceeds to block 104. At block 104, an intermediate representation of the source code is generated in a known fashion.

For at least one embodiment, a compiler's intermediate representation of a software program includes a symbol table and a list of instructions. The intermediate representation may be in an intermediate language maintained by the compiler, where the intermediate language is neither the source language nor machine instructions. The intermediate representation records information about the identifiers and user-defined entities in the source program (variables and other symbols, operators, operands, etc.), and the relationships between them.

From block 104, processing proceeds to block 106. At block 106, the intermediate representation generated at block 104 is modified to more efficiently handle any bit field processing present in the source code. Bit field processing includes definition of bit fields, initializing bit fields, writing values to bit fields, reading the values of bit fields, and testing the values of bit fields. Block 106 generates a modified intermediate representation that has been optimized for bit fields.

Processing proceeds from block 106 to block 108. At block 108, object code is generated based on the optimized intermediate representation generated at block 106. Processing then ends at block 110.

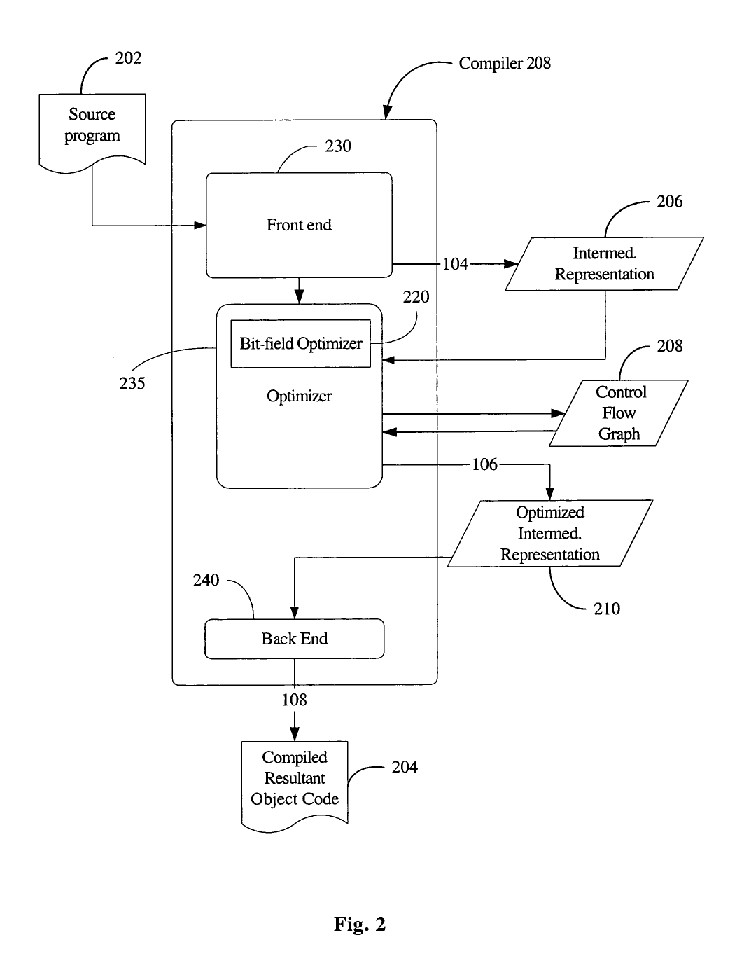

FIG. 2 is a data flow diagram illustrating data flow according to the method 100 illustrated in FIG. 1. Furthermore, FIG. 2 illustrates data flow according to an embodiment wherein the method 100 is performed by a compiler 208.

FIG. 2 illustrates that the compiler 208 includes a front end 230, an optimizer 235, and a back end code generator 240. The optimizer 235 includes a bit field optimizer 220. The front end 230 may generate 104 an intermediate representation 206 of the source program 202 in a known manner. For at least one embodiment, the intermediate representation 206 may be optimized in various known manners (i.e., dead code elimination, partial redundancy elimination, single static assignment, loop invariance hoisting, etc.) but does not include bit field optimizations. For at least one other embodiment, the intermediate representation 206 includes no optimizations.

The optimizer 235 identifies the basic blocks of the intermediate representation 206. Each basic block is a series of instructions, operators, operands and symbols grouped into a section. The basic block begins with a label and ends with a branch instruction. A basic block is defined such that each instruction within the basic block's grouping of instructions is executed sequentially, without any branches. The optimizer 235 also generates a control flow diagram 208. The edges in the control flow graph 208 denote the flow of control among the basic blocks

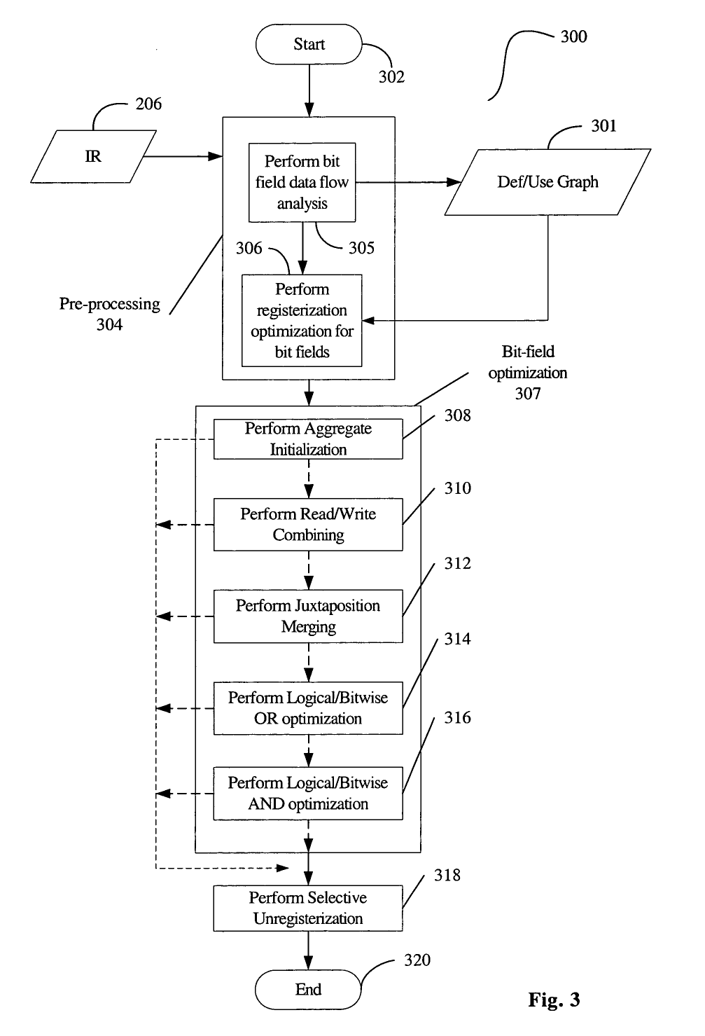

The bit field optimizer 220 of the optimizer 235 modifies 106 the intermediate representation 206 to more efficiently handle bit field processing. The optimizer 220 then generates 106 an optimized intermediate representation 219. Details regarding bit field optimization are discussed in further detail below in connection with FIG. 3.

The back end code generator 240 receives the optimized intermediate representation 210 as an input and generates 108 compiled resultant object code 204. The compiled code 204 contains optimizations that make bit field processing execute more efficiently.

FIG. 3 is a flow diagram illustrating in further detail at least one embodiment of a method 300 for optimizing an intermediate representation 206 to generate an intermediate representation 210 that provides for more efficient bit field processing. The method 300 may be performed by a bit-field optimizer 220 (FIG. 2).

The method 300 includes pre-processing 304, specific bit-field optimization 307, and selective unregisterization 318. Rather than merely disclosing a series of ad-hoc specific bit-field optimizations 308-318, the method 300 instead provides a framework into which other specific optimizations may be easily incorporated during bit-field optimization 307.

FIG. 3 illustrates at least one embodiment of control flow and data flow for a method 300 for optimizing.

FIG. 3 illustrates that the method 300 begins at block 302 and proceeds to a pre-processing block 304 and then to a bit-field optimization block 307. The bit-field optimization block 307 includes one or more specific optimization blocks 308, 310, 312, 314, 316 that may be performed in order to generate 106 an optimized intermediate representation 210. One of skill in the art will recognize that the processing of any one or more of the illustrated specific optimization blocks 308, 310, 312, 314, and 316 may provide an efficiency benefit. However, not all blocks need be performed in order to realize efficiency gains. Accordingly, dotted lines in FIG. 3 illustrate that any one specific processing block 308, 310, 312, 314, 316, or any combination of more than one such blocks, may be performed during bit field optimization 307. In order to provide an illustrative, though not all-inclusive, idea of the scope of the specific processing blocks 308, 310, 312, 314, and 316, it is noted that each of the illustrated specific optimization blocks 308, 310, 312, 314, and 316 may be performed on variables, temporary variables, pointer dereferences and array subscripts.

Pre-processing 304 includes at least two operations: data flow analysis 305 and registerization 306. By performing these two pre-processing blocks 305, 306, the method 106 performs preliminary processing of the intermediate representation 206 in order to better understand the constructs of the source program 202 (FIG. 2).

Generally, during pre-processing 304 statements using bit-fields and the logical “OR” connective of the format if (bit field//bit field//bit field// . . . ) are converted into statements using bit-fields and the bit-wise “OR” operator of the format if (bit field/bit field/bit field). Such conversion is performed before the optimizer 235 generates the CFG 208 (FIG. 2) and breaks up the single “if” statement into multiple “if” statements residing in multiple basic blocks. Such conversion is performed during pre-processing 304 only if the statement satisfies a “evaluate to Boolean condition” criterion.

During data flow analysis 305, the method 300 performs data flow analysis for bit fields. During data flow analysis 305, information regarding all bit fields in the entire source program is gathered. For each basic block (that is, for each node of the control flow graph 208 shown in FIG. 2), of the intermediate representation 206 of the source program, all definitions/uses of every bit field are collected. This def/use data is then catalogued and classified according to which packet of storage it is associated with. The def/use information is also classified according to its offset within its associated packet. This type of classification is the basis upon which certain further bit field section analysis is based. (See, for example, the discussion of blocks 308 and 310, below).

The method 300 thus analyzes 305 the definitions and usages of bit-field variables, arrays and pointers in the intermediate representation 206 to generate a def/use graph 301. The def/use graph 301 is an input into the second pre-processing block, the registerization block 306.

At block 306, a temporary variable is allocated for each bit field variable; the temporary variable is thus assigned to hold the bit field data that is to be manipulated by one or more instructions in the source program 202 (FIG. 2). That is, registerization 306 is a process by which bit field variables are replaced with equivalent temporary compiler-generated variables. Registerization thus reduces the overhead associated with reading from and writing to memory.

Registerization 306 also modifies the IR so that instructions that process the bit field data operate on the temporary variable rather than the memory variable indicated by the instruction in the source program 202 (FIG. 2). For example, Table 2 illustrates the result of registerization on a sample snippet of code shown in the first column of Table 2. According to the instructions of the snippet, bit fields of two structures, a and b, are accessed. In the registerized code, t1 and t2 are temporary variables allocated for a and b, respectively, and are processed by bit-field processing instructions.

TABLE 2

| Original code snippet | Resultant code after registerization |
|---|---|
| | t1 = a; t2 = b /* read a and b from memory */ |
| b (1:1) = a(1:1) | t2 (1:1) = t1 (1:1) |
| b(3:3) = a(3:3) | t2 (3:3) = t1 (3:3) |
| b(5:5) = a(5:5) | t2 (5:5) = t1 (5:5) |
| | b = t2 /* write b to memory */ |

Registerization 306 may be performed for entire bit-field variables (such as the variable “packet” illustrated in Table 1). This is illustrated in Table 2, where temporary variables t1 and t2 are allocated for the all bits of variables a and b, respectively. In addition to, or instead of, entire bit-field variable replacement, registerization 306 may be performed to replace bit field sections (such as “packet.network_flag1” illustrated in Table 1) with temporary compiler-generated bit field variables.

Table 2 illustrates that the registerized code snippet includes a maximum of one read instruction from memory (“t2=b”, “t1=a”), which is referred to herein as a “pre-fetch” instruction, for each bit field variable, pointer dereference or array subscript in the original code. Similarly, the registerized code snippet includes a maximum of one write instruction to memory (“b=t2”), which is referred to herein as a “post-store” instruction, for each bit field variable, pointer dereference or array subscript in the original code. In contrast, without registerization 306, the following resultant pseudo-code shown in Table 3 might be generated for the code snippet illustrated in the first column of Table 2:

TABLE 3

| | |
|---|---|
| 1. | Read a from DRAM into cache |
| 2. | Extract bit 1 from a in cache |
| 3. | Write extracted data to b in DRAM |
| 4. | Read a from DRAM into cache |
| 5. | Extract bit 3 from a in cache |
| 6. | Write extracted data to b, in DRAM |
| 7. | Read a from DRAM into cache |
| 8. | Extract bit 5 from a in cache |
| 9. | Write extracted data to b in DRAM |

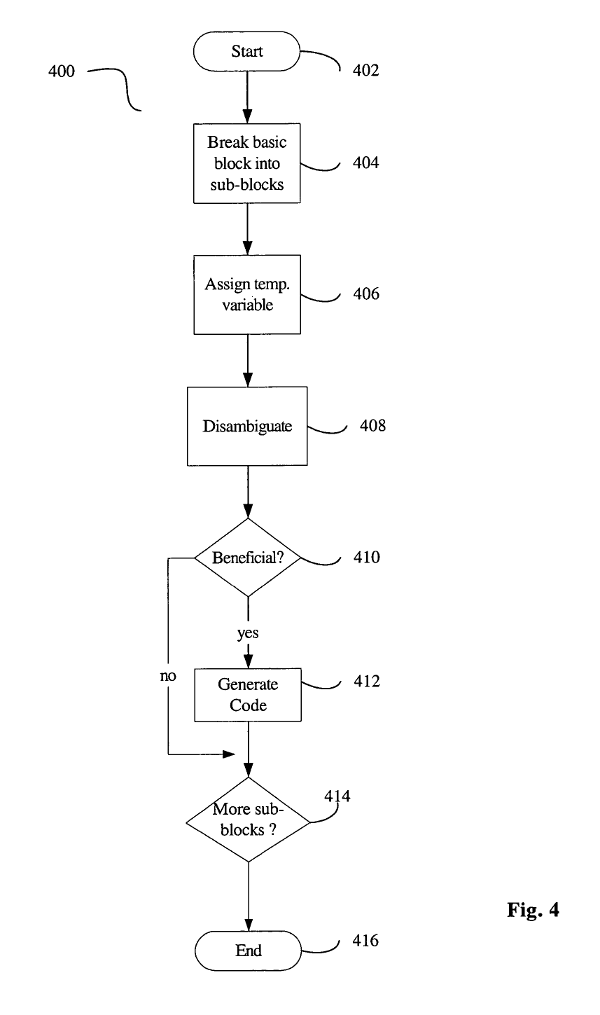

At block 306, registerization may be performed locally (within a single basic block) as well as globally (across more than one basic block). Brief reference to FIG. 4 illustrates at least one embodiment of a method 400 for performing local registerization for a single basic block at block 306.

FIG. 4 illustrates that processing for local registerization 400 begins at block 402 and proceeds to block 404. At block 404 the method 400 performs local analysis on the def/use graph 301 (FIG. 3) and breaks the basic block into sub-blocks as configured by the edges of the def/use graph. Processing then proceeds to block 406.

At block 406, a pre-fetch instruction is generated such that a temporary variable is assigned at the beginning of each sub-block. At the end of each sub-block, a post-read instruction is generated such that the value of the temporary variable is written to memory. For at least one embodiment, registerization 306 is not performed if it is determined that registerization is not desirable.

Block 406 may thus include analysis to determine whether temporary variables need be initialized via pre-fetch instructions. For instance, if it is determined that all accesses to bit fields in the block are read-after-write accesses, then initialization of temporary variables for such bit fields is not needed and pre-fetch instructions to perform such initialization would be extraneous. Accordingly, if all accesses to bit fields in the sub-block are read-after-write accesses, a temporary variable is not initialized in a pre-fetch instruction for the sub-block at block 406. Similarly, if it is determined that the intermediate representation does not include any write accesses to bit fields, then temporary variables need not be finalized. Accordingly, if the sub-block contains no write accesses to a bit-field variable, then a post-store instruction is not generated for the variable at block 406.

From block 406, processing for local registerization proceeds to block 408. At block 408, the method 400 disambiguates memory references in the sub-blocks. Disambiguation is the process of determining whether two memory instructions reference the same memory location. For at least one embodiment, the method 400 utilizes the existing disambiguator of the optimizer 235 to disambiguate 408 memory references to bit fields in the sub-blocks.

From block 408, processing proceeds to block 410. At block 410 the method performs pack analysis and overlap analysis. These types of analysis are particularly relevant to optimization of bit fields of structures that are array subscripts or are dereferenced by pointers. During pack analysis, sections of bits within a packet are analyzed. More specifically, memory layout is analyzed regarding all the bit fields of the packet that the optimizer has encountered in the sub-basic block. During pack analysis, bit offsets are with respect to the beginning of the packet.

At block 410, overlap analysis, which takes into consideration the address taken, is also performed. During overlap analysis, it is determined whether two bit fields of a structure, where each of the bit fields is read and/or written in the sub-basic block, overlap. In other words, it is determined whether some bits of one bit field actually reside in the same memory location of some other bits of another bit field. Processing then proceeds to block 412.

At block 412 a rudimentary benefits analysis is performed to determine whether the performance benefit of registerization outweighs the cost. If so, registerization code (pre-fetch and post-store, if warranted) is generated. Accordingly, if the benefits analysis is positive, then registerization code is generated at block 412 for a complete write or initialization. Also at block 412, registerization code is generated for contiguous single bit fields.

At block 414 it is determined whether the processing at blocks 406-412 have been performed for each sub-block identified at block 404. If not, processing loops back to block 406. In this manner, local registerization is performed for all sub-blocks identified at block 404. Processing then ends at block 416.

Reference back to FIG. 3 illustrates that completion of registerization 306 signifies the end of pre-processing 304. After such pre-processing 304 has been performed, all bit fields of interest are represented by compiler-generated temporary variables and have been disambiguated. Such state provides a logical starting point for bit-field optimization 307 and provides for simplified processing during optimization 307. Optimization processing 307 is simplified in that specific processing blocks 308, 310, 312, 314, and 316 need not distinguish between bit fields that are user-defined scalar variables, array subscripts or structure pointer dereferences: they have all been replaced by the temporary variables and may thus be optimized indiscriminately.

FIG. 3 illustrates that bit field optimization 307 includes an aggregate initialization block 308 and a read/write combining block 310. The goal of the read/write combining optimization 310 as well as the aggregate initialization optimization 308 is to reduce the number of read and write accesses to the memory hierarchy by merging like accesses.

Merging of two or more like accesses may be performed during blocks 308 and 310 as long as each of the accesses to be merged falls within a predefined maximal scope. Bit field reads and writes may be scattered non-consecutively within the maximal scope. As long as there are no intervening reads or writes between two non-consecutive accesses to a bit field, where the two accesses both fall within the maximal scope, the two accesses may be grouped together and merged at block 308 and/or block 310. More specifically, blocks 308 and 310 allow non-consecutive accesses to a bit field to be merged if the two accesses meet certain generalized code motion constraints.

Both aggregate initialization 308 and read/write combining 310 are accomplished via “section analysis.” The entire maximal scope containing bit-field reads, initializations, or writes are analyzed before the optimized IR 210 is generated 106 (see FIG. 2). The order in which the to-be-combined statements occur within the IR 206 is not determinative—like accesses to a bit-field entity may be merged regardless of their relative order.

As a result of at least one embodiment of both aggregate initialization 308 and read/write combining 310, the modified IR includes a bit mask. For example, consider again the code snippet illustrated in the first column of Table 2. The series of instructions is assumed to reside within a maximal scope and may have non-intervening instructions between them. As is stated above, without the specific optimizations discussed herein, a compiler might generate the pseudo-code for the series of instructions illustrated above in Table 3. Table 3 illustrates that the pseudo-code includes three read instructions (rows 1, 4 and 7) and three write instructions (rows 3, 6 and 9). The example snippet of Table 2 and the pseudo-code of Table 3 are referenced in the discussion below, in which the read combining and write combining functions of block 310 are discussed separately.

In order to read the bit values of the variable “a” that are utilized during the code snippet illustrated in Table 2, Table 3 indicates three read instructions at rows 1, 4 and 7. At block 310, these read operations are combined using a bit mask. That is, the value of “a” is retrieved from DRAM memory only once. The pseudo-code statements illustrated at rows 1 and 2 of Table 4a illustrate such processing. For illustrative purposes, it is assumed that bit 1 is the left-most bit of a word.

TABLE 4a

| | |
|---|---|
| 1. | t1 = a /* read a from memory into cache*/ |
| 2. | t1 = t1 & 1b’101010 . . . 0 ‘/* mask out all but |
| | bits 1, 3 and 5 */ |
| 3. | Extract bit 1 from a in cache (t1) |
| 4. | Write extracted data to b in DRAM |
| 5. | Extract bit 3 from a in cache (t1) |
| 6. | Write extracted data to b in DRAM |
| 7. | Extract bit 5 from a in cache (t1) |
| 8. | Write extracted data to b in DRAM |

Once the first and second rows of Table 4a have been performed, the desired bit values of a (that is, bits 1, 3 and 5) reside in the temporary variable t1. Such combined read operation is performed with a single memory access instead of the three memory accesses illustrated in Table 3.

If one did not mind corruption of the remaining bits of b, the value of the temporary variable t1 could be assigned to b in order to combine the write operations illustrated at rows 4, 6 and 8 of Table 4a. However, the write combining function performed at block 310 is more robust in that only the desired bits of variable b are written. Table 4b illustrates that the write-combining operation of block 310 utilizes a bit mask to achieve such result.

TABLE 4b

| | |
|---|---|
| 1. | t1 = a /* read a from memory into cache*/ |
| 2. | t1 = t1 & 1b’101010 . . . 0 ‘/* mask out all but |
| | bits 1, 3 and 5 */ |
| 3. | t2 = b /* read b from memory into cache */ |
| 4. | t2 = t2 & 1b’0101011 . . . 1’ /* initialize bits 1, |
| | 3, and 5 to zero; preserve value of remaining |
| | bits of b*/ |
| 5. | b = t1 \| t2 /* assign bits 1, 3 and 5 of a to b |
| | and write extracted data to b in DRAM |

Regarding write-combining, bit field code is not generated at block 310 in the case of an eventual “complete write”. For example, assuming that a and b are 32-bit entities, the statement “b=a” is generated at block 310 for the following series of sample instructions: b(31:32)=a(31:32); b(1:2)=a(1:2); and b(3:30)=a(3:30).

Also at block 310, if the combined read or write instructions access a contiguous section of an entity, a bit field is generated instead of using bit mask. For example, consider the code snippets illustrated in Table 5. Block 310 generates code involving a bit mask to combine the non-contiguous read/write operations of the first code snippet, but does not generate code involving a bit mask for the second snippet:

TABLE 5

| | | | Resultant code |
|---|---|---|---|
| Original code | Resultant code after read/write | Original code | after read/write |
| snippet #1 | combining 310 | snippet #2 | combining 310 |
| b (5:7) = a (5:7) | t1 = a /* read a from memory into | b (4:7) = a (4:7) | b (1:7) = a (1:7) |
| | cache*/ | | |
| b (1:3) = a (1:3) | t1 = t1 & 1b’11101110 . . . 0 ‘ | b (1:3) = a (1:3) | |
| | /* mask out all bits except 1-3 | | |
| | and 5-7*/ | | |
| | t2 = b /* read b from memory into | | |
| | cache */ | | |
| | t2 = t2 & 1b’00010001 . . . 1’ | | |
| | /* initialize bits 1-3, 5-7 to zero; | | |
| | preserve value of other bits of b */ | | |
| | b = t1 \| t2 /* assign bits 1-3, 5-7 of | | |
| | a to b and write extracted data to b | | |
| | in DRAM | | |

Table 6 illustrates that shifted copying of bit fields from one variable to another is also supported during read/write combining 310. As is true of non-shifted copying of bits fields, as illustrated in Table 5, the method 300 may utilize a bit mask for shifted copies of non-contiguous read/write accesses.

TABLE 6

| Original code | | Original code | |
|---|---|---|---|
| snippet #1 (non- | | snippet #2 | Resultant code |
| contiguous | Resultant code after read/write | (contiguous | after read/write |
| shift/copy) | combining 310 | shift/copy) | combining 310 |
| b (7:9) = a (5:7) | t1 = a /* read a from memory into | b (6:9) = a (4:7) | b (3:9) = a (1:7) |
| | cache*/ | | |
| b (3:5) = a (1:3) | t1 = (t1 & 1b’11101110 . . . 0 ‘) >> | b (3:5) = a (1:3) | |
| | 2 | | |
| | /* mask out all bits except 1-3 and | | |
| | 5-7; shift result right by 2 bits */ | | |
| | t2 = b /* read b from memory into | | |
| | cache */ | | |
| | t2 = t2 & 1b’1100010001 . . . 1’ | | |
| | /* initialize bits 3-5, 7-9 to zero; | | |
| | preserve value of other bits of b */ | | |
| | b = t1 \| t2 /* assign bits 1-3, 5-7 of | | |
| | a to bits 3-5, 7-9 of b and write | | |
| | extracted data to b in DRAM | | |

Regarding more specific details regarding aggregate initialization of bit fields 308, it has been stated above that aggregate initialization 308, like read/writing combining 310, is based on section analysis. The entire maximal scope is analyzed for bit field initializations before any optimized code is generated. All initializations for the same bit-field variable that occur within the maximal scope are aggregated at block 308. Table 7 provides an example of such aggregated initialization 308 for a sample snippet of code. As with the snippets illustrated in Tables 2, 5 and 6, the instructions of the snippet code illustrated in Table 7 need not be contiguous; they may be scattered throughout the maximal scope of the IR 206, as long as only non-intervening instructions separate the instructions of the snippet.

TABLE 7

| Original | |
|---|---|
| code | Resultant code after aggregate |
| snippet | initialization optimization 308 |
| b (1:1) = 1 | t2 = b /* read b from memory into cache*/ |
| b(3:3) = 0 | t2 = t2 & 1b’0101011 . . . 1’ /* |
| b(5:5) = 1 | preliminary initialization of bits 1, 3 and 5 |
| | to zero; preserve value of other bits of b */ |
| | t1 = 1b’ 1000100 . . . 0 ‘ /* |
| | create mask to initialize desired bits*/ |
| | b = t1 \| t2 /* initialize bits 1 and 5 |
| | of b to 1b’1’; initialize bit 3 of b to |
| | zero, preserve value of remaining bits of b; |
| | write b to DRAM */ |

As is true of the read/write combining optimization 310, at least one embodiment of the aggregate initialization optimization 308 does not generate bit field code in the case of an eventual “complete initialization”. For example, assuming that b is a 32-bit entity, b is assigned to a simple bit mask value for the following series of sample instructions: b(31:32)=1b‘01’; b(1:2)=1b‘11’; and b(3:30)=0. For such series of instructions, the aggregate initialization optimization block 308 generates the following statement: b=1b‘110 . . . 001’.

The remaining specific optimization blocks 312, 314, 316 seek to exploit the locality of adjacent bits. As a result of juxtaposition merging 312, logical/bitwise OR optimization 314, and logical/bitwise AND optimization 316, adjacent bits that undergo similar relocations (shifts, insertion, extraction) remain adjacent. These specific optimization blocks 312, 314, 316 keep track of such relocations and optimize the resulting uses of these adjacent bits. These types of specific optimizations 312, 314, 316 tend to be beneficial for code that is to be performed by a network processor because network processing applications typically involve checking the status of signals and other bit-packing occurrences.

Juxtaposition merging 312 attempts to exploit the locality of adjacent bits based on an analysis of bit fields that are operands for bitwise “or” and bitwise “and” operators (with allowance for bitwise shift operations). For example, consider the following statement: b=a (1:3)<<5|a(4:4)<<4|a(5:7)<<1. The statement includes three left-shifted operands for a Boolean bit-wise “or” operation.

Without the juxtaposition merging optimization 312, a compiler might generate the code for such statement as illustrated in Table 8a. For the example illustrated in Table 8a, it is assumed that the right-most bit of a word is the least significant bit.

TABLE 8a

| Code | Logical representation |
|---|---|
| t1 = a(1:3) /* read bits 1-3 of a into least | t1 = [ . . . 0 0 0 0 0 0 1 2 3] |
| significant bits of temporary variable */ | |
| t1 = t1 << 5 /* left shift */ | t1 = [ . . . 0 1 2 3 ] |
| t2 = a (4:4) /* read bit 4 of a into least | t2 = [ . . . 0 0 0 0 0 0 4] |
| significant bits of temporary variable */ | |
| t2 = t2 << 4 /* left shift */ | t2 = [ . . . 0 0 4 ] |
| t3 = a(5:7) /* read bits 5-7 of a into least | t3 = [ . . . 0 0 0 0 0 0 5 6 7] |
| significant bits of temporary variable */ | |
| t3 = t3 << 1 /* left shift */ | t3 = [ . . . 0 0 0 0 0 5 6 7 ] |
| b = t1 \| t2 \| t3 /* write b to memory */ | t1 = [ . . . 0 1 2 3 ] OR |
| | t2 = [ . . . 0 0 4 ] OR |
| | t3 = [ . . . 0 0 0 0 0 5 6 7 ] |
| | b = [ . . . 0 1 2 3 4 5 6 7 ] |

In contrast, Table 8b illustrates the simplified code generated according to the juxtaposition optimization 312:

TABLE 8b

b = a (1:7) << 1

Similarly, at least one embodiment of the juxtaposition merging optimization 312 may be performed on bit fields used as operands for the bitwise Boolean “and” operator. For example, consider the following statement: b=a (1:3)<<5 & a (4:4)<<4 & a (5:7)<−1. Instead of the code illustrated in FIG. 9a, which might be generated by a compiler without the juxtaposition optimization 312, the code of FIG. 9b is generated based on the juxtaposition optimization 312. For Table 9a, it is assumed that temporary variables are initialized to null values and that the right-most bit of a word is the least significant bit.

TABLE 9a

| Code | Logical representation |
|---|---|
| t1 = a(1:3) /* read bits 1-3 of a into least | t1 = [ . . . 0 0 0 0 0 0 1 2 3] |
| significant bits of temporary variable */ | |
| t1 = t1 << 5 /* left shift */ | t1 = [ . . . 0 1 2 3 ] |
| t2 = a (4:4) /* read bit 4 of a into least | t2 = [ . . . 0 0 0 0 0 0 4] |
| significant bits of temporary variable */ | |
| t2 = t2 << 4 /* left shift */ | t2 = [ . . . 0 0 4 ] |
| t3 = a(5:7) /* read bits 5-7 of a into least | t3 = [ . . . 0 0 0 0 0 0 5 6 7] |
| significant bits of temporary variable */ | |
| t3 = t3 << 1 /* left shift */ | t3 = [ . . . 0 0 0 0 0 5 6 7 ] |
| b = t1 & t2 & t3 /* write b to memory */ | t1 = [ . . . 0 1 2 3 ] AND |
| | t2 = [ . . . 0 0 4 ] AND |
| | t3 = [ . . . 0 0 0 0 0 5 6 7 ] |
| | → [ . . . 0 0 0 0 0 5 6 7 ] ∴ b = 0 |

Table 9b illustrates the simplified code generated according to the juxtaposition optimization 312:

TABLE 9b

b = 0

At block 314, the method 106 performs merging of bitwise “or” fields with other bitwise “or” fields of the same bit-field entity. The optimization 314 also merges logical “or” fields with other logical “or” fields of the same bit-field entity. This merging is accomplished by analyzing all bit fields in the maximal scope that are OR-'d together. For at least one embodiment, the optimization of block 314 is performed only when the fields that are OR'ed together result in a Boolean entity. For at least one embodiment, the optimization 314 is performed on conditional expressions of “if” statements.

For example, consider the following two statements:
a. if (a(1:3)!=0∥a(4:4)!=0∥a(5:7)!=0)
b. if ((a(1:3)|a(4:4)|a(5:7))!=0)
   For both statements a and b, the same “or” statement is generated according to the “or” optimization block 314: “if (a(1:7)!=0)”. In such manner, the multiple bit fields may be evaluated with a single read instruction.

At block 316, the method 106 performs merging of logical “and” fields with other logical “and” fields of the same bit-field entity. This merging is accomplished by analyzing all bit fields in the maximal scope that are AND-'ed together. As with “OR” merging 314, at least one embodiment of the “AND” merging optimization 316 performed on conditional expressions of “if” statements.

For example, consider the following sample statement: if (a(1:3)==0 && a(4:4)==0 && a(5:7)==0). According to the “and” optimization block 316, the following statement is generated for the sample statement: (if a(1:7)==0). Again, the result of the optimization 316 is that multiple bit fields may be evaluated with a single read instruction.

FIG. 3 illustrates that after one or more of the specific optimization blocks 308, 310, 312, 314, 316 are performed during optimization 307, processing proceeds to block 318. At block 318, unregisterization is performed. Unregisterization may be conceptualized as the reverse process of registerization 306. However, for efficiency reasons at least one embodiment of unregisterization 318 is selectively performed. That is, replacing bit field variables by compiler-generated temporary variables generally improves execution performance, especially in the cases where the bit field variables are allocated in SRAM or DRAM, or when the bit field accesses involve array subscripts or structure pointer dereferences. Nevertheless, such replacement typically increases the size of the generated code (which can often lead to performance loss). Accordingly, unregisterization 318 employs a heuristic-driven approach to selectively reverse the process of registerization only when such reversal is anticipated to provide an efficiency advantage in the resulting optimized code.

For example, for at least one embodiment, registerization code to assign temporary variables for variables is nullified during selective unregisterization 318 if it is determined that such code may degrade performance of the ultimate compiled resultant object code 204 (FIG. 2). However, unregisterization is not performed at block 318 for temporary variables assigned to pointer dereferences and array subscripts—such temporary variables remain in the optimized IR 210 (FIG. 2).

During unregisterization, constants used for bitwise “and” and “or” statements are folded and propagated. Regarding folding, expressions whose values are known at compilation time are simplified, if possible. For example, consider the following sample code snippet within a sub-basic block:
t1=0 {initialized by registerization} (5)
t2=t1& “<some bit pattern>”|˜“<some other bit pattern>” (6)
During registerization, statement 6 may be simplified by placing the constant value (zero) of t1 into the right-hand side of the expression: t2=0 & “<some bit pattern>”|˜“<some other bit pattern>”. Furthermore, such value for t1 may be propagated to later statements in the sub-basic block as well.

Embodiments of the methods 100, 300, 400 disclosed herein may be implemented in hardware, software, firmware, or a combination of such implementation approaches. Software embodiments of the methods 100, 300, 400 may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this disclosure, a processing system includes any system that has a processor, such as, for example; a network processor, a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the methods described herein are not limited in scope to any particular programming language. In any case, the language may be a compiled or interpreted language

The programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system. The instructions, accessible to a processor in a processing system, provide for configuring and operating the processing system when the storage media or device is read by the processing system to perform the actions described herein. Embodiments of the invention may also be considered to be implemented as a machine-readable storage medium, configured for use with a processing system, where the storage medium so configured causes the processing system to operate in a specific and predefined manner to perform the functions described herein.

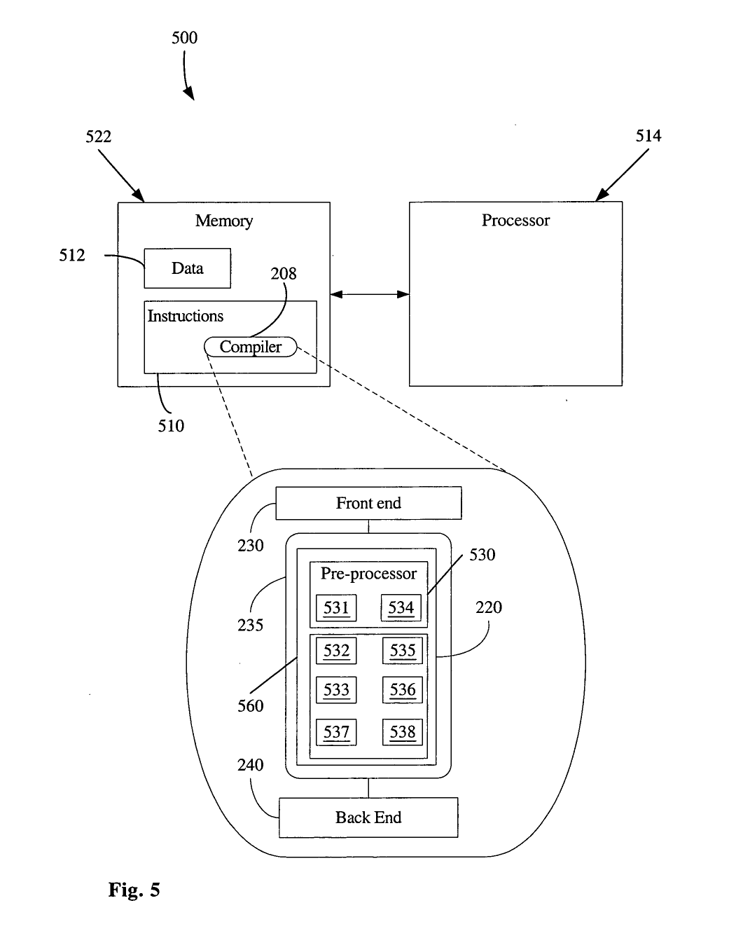

An example of one such type of processing system is shown in FIG. 5. System 500 may be used, for example, to execute the processing for a method of optimizing bit fields in software code, such as the embodiments described herein. System 500 is representative of processing systems based on the Intel® IXP220 Service-Specific Network Processor and the Intel® IXP225 Service-Specific Network Processor as well as the Itanium® and Itanium® 2 microprocessors and the Pentium®, Pentium® Pro, Pentium® II, Pentium® III, Pentium® 4 microprocessors, all of which are available from Intel Corporation. Other systems (including personal computers (PCs) and servers having other microprocessors, engineering workstations, personal digital assistants and other hand-held devices, set-top boxes and the like) may also be used. At least one embodiment of system 500 may execute a version of the Windows™ operating system available from Microsoft Corporation, although other operating systems and graphical user interfaces, for example, may also be used.

Processing system 500 includes a memory 522 and a processor 514. Memory system 522 may store instructions 510 and data 512 for controlling the operation of the processor 514. Memory system 522 is intended as a generalized representation of memory and may include a variety of forms of memory, such as a hard drive, CD-ROM, random access memory (RAM), dynamic random access memory (DRAM), static random access memory (SRAM), flash memory and related circuitry. Memory system 522 may store instructions 510 and/or data 512 represented by data signals that may be executed by the processor 514. For an embodiment wherein the method 100 is performed by a compiler, instructions 510 may include a compiler program 208.

FIG. 5 illustrates that the instructions implementing an embodiment of the methods 100, 300, 400 discussed herein may be logically grouped into various functional modules. For a compiler 208 that includes functional groupings of instructions known as front end 230, optimizer 235, and back end 240, the methods 100, 300, 400 may be performed with the optimization grouping of instructions 235. More specifically, at least one embodiment of methods 100, 300, 400 may be performed by a bit-field optimizer 220.

Compiler 208 may include a pre-processor 530 and a specific bit-field optimizer 560. When executed by processor 514, at least one embodiment of bit-field optimizer 220 performs bit-field optimization as described above in connection with FIGS. 1, 3, and 4.

When executed by processor 514, pre-processor 530 performs preliminary processing of the intermediate representation 206 (FIG. 2) as described above in connection with FIGS. 3 and 4. At least one embodiment of pre-processor 530 may include data flow analyzer 531 and registerizer 534.

When executed by processor 514, data flow analyzer 531 generates a def/use graph as described above in connection with FIG. 3. When executed by processor 514, registerizer 534 performs registerization as described above in connection with FIGS. 3 and 4.

When executed by processor 514, at least one embodiment of specific bit-field optimizer 560 performs bit-field optimization 307 as described above in connection with FIG. 3. The specific bit-field optimizer 560 may include aggregate initializer 532, read/write combiner 533, juxtaposition merger 535, “or” optimizer 536, “and” optimizer 537, and unregisterizer 538.

The aggregate initializer 532, read/write combiner 533, juxtaposition merger 535, “or” optimizer 536 and “and” optimizer 537 perform aggregate initialization 308, read/write combining 310, juxtaposition merging 312, “or” optimization 314, and “and” optimization 316, respectively, as described above in connection with FIG. 3. In addition, unregisterizer 318, when executed by processor 514, performs selective unregisterization 318 as described above in connection with FIG. 3.

In the preceding description, various aspects of a method, apparatus and system for optimizing bit fields in compiled code are disclosed. For purposes of explanation, specific numbers, examples, systems and configurations were set forth in order to provide a more thorough understanding. However, it is apparent to one skilled in the art that the described method and apparatus may be practiced without the specific details. It will be obvious to those skilled in the art that changes and modifications can be made without departing from the present invention in its broader aspects.

For example, the optimization 307 (FIG. 3), pre-processing (304) and local registerization 400 (FIG. 4) have been illustrated as having a particular control flow. One of skill in the art will recognize that alternative processing order may be employed to achieve the functionality described herein. Similarly, certain operations are shown and described as a single functional block. Such operations may, in practice, be performed as a series of sub-operations.

While particular embodiments of the present invention have been shown and described, the appended claims are to encompass within their scope all such changes and modifications that fall within the true scope of the present invention.

1. A method comprising:
generating an intermediate representation (IR) of a source program, where the source program includes one or more instructions for processing data in a bit field within a data structure;
modifying the intermediate representation to more efficiently execute the one or more instructions for processing the bit field data; and
generating resultant code based on the modified intermediate representation.

2. The method of claim 1, wherein modifying the intermediate representation further comprises:
pre-processing the IR to perform preliminary modification of the IR.

3. The method of claim 2, wherein modifying performing pre-processing further comprises:
performing data flow analysis to gather information regarding definition and usage of the bit field data; and
generating a def/use graph to classify the information.

4. The method of claim 3, wherein generating a def/use graph further comprises:
generating a def/use graph to classify the information in relation to an associated packet.

5. The method of claim 2, wherein modifying the intermediate representation further comprises:
(a) allocating a temporary variable to hold the bit field data; and
(b) modifying the IR so that the temporary variable is processed in accordance with the instructions.

6. The method of claim 5, further comprising:
(c) assigning the value of the temporary variable to a memory.

7. The method of claim 6, further comprising:
performing steps (a), (b) and (c) for a single basic block.

8. The method of claim 7, further comprising:
identifying two or more sub-blocks within the basic block.

9. The method of claim 8, wherein:
steps (a), (b) and (c) are performed for each sub-block.

10. The method of claim 5, further comprising:
determining whether all of the one or more instructions for processing the bit field data are read-after-write instructions; and
performing steps (a) and (b) only if the determination is false.

11. The method of claim 6, further comprising:
determining whether any of the one or more instructions for processing the bit field data are write instructions; and
performing step (c) only if the determination is true.

12. The method of claim 6, further comprising:
removing the modifications effected by steps (a), (b) and (c) upon determining that such removal is expected to provide an efficiency benefit in the resultant code.

13. The method of claim 2, wherein pre-processing further comprises:
disambiguating a memory reference to the bit field.

14. The method of claim 1, wherein modifying the intermediate representation further comprises:
modifying the IR so that multiple instructions to initialize respective bit fields of a data structure are performed with a single write to a memory.

15. The method of claim 14, wherein the multiple instructions occur within a pre-defined maximal scope.

16. The method of claim 1, wherein modifying the intermediate representation further comprises:
modifying the IR so that multiple read instructions for respective bit fields of a data structure are performed with a single read from a memory.

17. The method of claim 16, wherein the multiple read instructions occur within a pre-defined maximal scope.

18. The method of claim 1, wherein modifying the intermediate representation further comprises:
modifying the IR so that multiple write instructions to respective bit fields of a data structure are performed with a single write to a memory.

19. The method of claim 18, wherein the multiple read instructions occur within a pre-defined maximal scope.

20. The method of claim 1, wherein modifying the intermediate representation further comprises:
determining that a first instruction, being one of the one or more instructions, indicates a bit-wise logical operation on the bit field data;
determining that a second instruction of the source program indicates a bit-wise logical operation on a second bit field within the data structure; and
modifying the IR so that the first and second instructions are performed via a single read from a memory.

21. The method of claim 20, wherein the bit-wise logical operation is a bit-wise OR operation.

22. The method of claim 20, wherein the bit-wise logical operation is a bit-wise AND operation.

23. An article comprising:
a machine-readable storage medium having a plurality of machine accessible instructions, which if executed by a machine, cause the machine to perform operations comprising:
generating an intermediate representation (IR) of a source program, where the source program includes one or more instructions for processing data in a bit field within a data structure;
modifying the intermediate representation to more efficiently execute the one or more instructions for processing the bit field data; and
generating resultant code based on the modified intermediate representation.

24. The article of claim 23, wherein the instructions that cause the machine to modify the intermediate representation further comprise instructions that cause the machine to:
perform preliminary modification of the IR.

25. The article of claim 24, wherein the instructions that cause the machine to modify the intermediate representation further comprise instructions that cause the machine to:
gather information regarding definition and use of the bit field data; and
generate a def/use graph to classify the information.

26. The article of claim 25, wherein the instructions that cause the machine to generate a def/use graph further comprise instructions that cause the machine to:
generate a def/use graph to classify the information in relation to an associated packet.

27. The article of claim 24, wherein the instructions that cause the machine to modify the intermediate representation further comprise instructions that cause the machine to:
(a) allocating a temporary variable to hold the bit field data; and
(b) modifying the IR so that the temporary variable is processed in accordance with the instructions.

28. The article of claim 27, further comprising a plurality of machine accessible instructions, which if executed by a machine, cause the machine to perform operations comprising:
(c) assigning the value of the temporary variable to a memory.

29. The article of claim 28, further comprising a plurality of machine accessible instructions, which if executed by a machine, cause the machine to perform operations comprising:
performing steps (a), (b) and (c) for a single basic block.

30. The article of claim 29, further comprising a plurality of machine accessible instructions, which if executed by a machine, cause the machine to perform operations comprising:
identifying two or more sub-blocks within the basic block.

31. The article of claim 30, further comprising a plurality of machine accessible instructions, which if executed by a machine, cause the machine to perform operations comprising:
performing steps (a), (b) and (c) for each sub-block.

32. The article of claim 27, further comprising a plurality of machine accessible instructions, which if executed by a machine, cause the machine to perform operations comprising:
determining whether all of the one or more instructions for processing the bit field data are read-after-write instructions; and
performing steps (a) and (b) only if the determination is false.

33. The article of claim 28, further comprising a plurality of machine accessible instructions, which if executed by a machine, cause the machine to perform operations comprising:
determining whether any of the one or more instructions for processing the bit field data are write instructions; and
performing step (c) only if the determination is true.

34. The article of claim 28, further comprising a plurality of machine accessible instructions, which if executed by a machine, cause the machine to perform operations comprising:
removing the modifications effected by steps (a), (b) and (c) upon determining that such removal is expected to provide an efficiency benefit in the resultant code.

35. The article of claim 24, wherein the instructions that cause the machine to perform preliminary modification of the IR further comprise instructions that cause the machine to:
disambiguate a memory reference to the bit field.

36. The article of claim 23, wherein the instructions that cause the machine to modify the intermediate representation further comprise instructions that cause the machine to:
modify the IR so that multiple instructions to initialize respective bit fields of a data structure are performed with a single write to a memory.

37. The article of claim 36, wherein the multiple instructions occur within a pre-defined maximal scope.

38. The article of claim 23, wherein the instructions that cause the machine to modify the intermediate representation further comprise instructions that cause the machine to:
modify the IR so that multiple read instructions for respective bit fields of a data structure are performed with a single read from a memory.

39. The article of claim 38, wherein the multiple read instructions occur within a pre-defined maximal scope.

40. The article of claim 23, wherein the instructions that cause the machine to modify the intermediate representation further comprise instructions that cause the machine to:
modify the IR so that multiple write instructions to respective bit fields of a data structure are performed with a single write to a memory.

41. The article of claim 40, wherein the multiple read instructions occur within a pre-defined maximal scope.

42. The article of claim 23, wherein the instructions that cause the machine to modify the intermediate representation further comprise instructions that cause the machine to:
determine that a first instruction, being one of the one or more instructions, indicates a bit-wise logical operation on the bit field data;
determine that a second instruction of the source program indicates a bit-wise logical operation on a second bit field within the data structure; and
modify the IR so that the first and second instructions are performed via a single read from a memory.

43. The article of claim 42, wherein the bit-wise logical operation is a bit-wise OR operation.

44. The article of claim 42, wherein the bit-wise logical operation is a bit-wise AND operation.

45. A compiler comprising:
a front end to generate an intermediate representation of a source program;
an optimizer to modify the intermediate representation (R) to provide for optimized processing of one or more bit fields; and
a back end to generate resultant code based on the modified intermediate representation.

46. The compiler of claim 45, wherein:
the optimizer includes a pre-processor to perform preliminary processing of the intermediate representation.

47. The compiler of claim 46, wherein:
the pre-processor includes a data flow analyzer to perform data flow analysis and to generate a def/use graph.

48. The compiler of claim 46, wherein:
the pre-processor includes a registerizer to modify the intermediate representation to allocate a temporary variable for a bit field variable used in the source program.

49. The compiler of claim 47, further comprising:
an unregisterizer to selectively reverse the modification performed by the registerizer.

50. The compiler of claim 45, wherein:
the optimizer includes a bit-specific optimizer to modify the IR such that processing of bit fields indicated by the source program is more efficient.

51. The compiler of claim 50, wherein:
the bit-specific optimizer includes an aggregate initializer to initialize multiple bit fields within a data structure via a single write to memory.

52. The compiler of claim 50, wherein:
the bit-specific optimizer includes a read/write combiner to read multiple bit fields within a data structure via a single read from memory.

53. The compiler of claim 52, wherein:
the read/write combiner is further to initialize write bit fields within a data structure via a single write to memory.

54. The compiler of claim 50, wherein:
the bit-specific optimizer includes a juxtaposition merger to determine that a first instruction, being one of the one or more instructions, indicates a bit-wise logical operation on the bit field data;
the juxtaposition merger further to determine that a second instruction of the source program indicates a bit-wise logical operation on a second bit field within the data structure; and
the juxtaposition optimizer further to modify the IR so that the first and second instructions are performed via a single read from a memory.

55. The compiler of claim 50, wherein:
the bit-specific optimizer includes an “or” optimizer to merge logical “or” statements of a conditional statement together such that they are executed via a single read statement.

56. The compiler of claim 55, wherein:
the “or” optimizer is further to merge bit-wise “or” statements of a conditional statement together such that they are executed via a single read statement.

57. The compiler of claim 50, wherein:
the bit-specific optimizer includes an “and” optimizer to merge logical “and” statements of a conditional statement together such that they are executed via a single read statement
